(19) United States
(12) Patent Application Publication
(10) Pub. No.: US 2007/0043849 A1
(43) Pub. Date: Feb. 22, 2007

(54) Field data collection and processing system, such as for electric, gas, and water utility data

(76) Inventors: David Lill, Spokane, WA (US); Eric Benson, Spokane, WA (US); Michael Benton, Rathdrum, ID (US); Robert Lusian, Spokane, WA (US); James P. Wall, Spokane, WA (US); Stephanie Wallis, Veradale, WA (US); Andrea Piccolo, Mead, WA (US)

Correspondence Address: PERKINS COIE LLP;PATENT-SEA, P.O. BOX 1247, SEATTLE, WA, 98111-1247, US

(21) Appl. No.: 10/571,043

(22) PCT Filed: Sep. 5, 2003
(86) PCT No.: PCT/US03/27739

§ 371 Date: Oct. 27, 2006

(51) Int. Cl. G06F 15/173

(52) U.S. Cl. 709/224

(57) ABSTRACT

A method and system for data collection and processing, such as for collection and processing of data read by a utility meter, generates a message having header information, a first packet having data of a first type, and a second packet having data of a second type. Each packet includes header information that identifies the data type of the packet The system also includes a head-end subsystem with multiple processors, each for processing a distinct data type. A message organizer component delegates each of the packets of data to the appropriate packet processor.

### CROSS-REFERENCE TO RELATED APPLICATIONS

This application is related to the following commonly assigned U.S. patent applications: U.S. patent application Ser. No. ______ (attorney docket no. 1725.173US01), filed on Sep. 5, 2003, entitled “System and Method for Detection of Specific On-Air Data Rate,” U.S. patent application Ser. No. ______ (attorney docket no. 1725.162US01), filed Sep. 5, 2003, entitled “System and Method for Mobile Demand Reset,” U.S. patent application Ser. No. ______ (attorney docket no. 1725.160US01), filed Sep. 5, 2003, entitled “System and Method for Optimizing Contiguous Channel Operation with Cellular Reuse,” U.S. patent application Ser. No. ______ (attorney docket no. 1725.156US01), filed Sep. 5, 2003, entitled “Synchronous Data Recovery System,” U.S. patent application Ser. No. ______ (attorney docket no. 1725.161US01), filed Sep. 5, 2003, entitled “Data Communication Protocol in an Automatic Meter Reading System,” U.S. patent application Ser. No. ______ (attorney docket no. 1725.167US01), filed Sep. 5, 2003, entitled “Response Optimization for Mobile and Fixed Network Operations,” and U.S. patent application Ser. No. ______ (attorney docket no. 10145-8011.US00), filed on Sep. 5, 2003, entitled “Synchronizing and Controlling Software Downloads, such as for Components of a Utility Meter-Reading System,” which are herein incorporated by reference.

### BACKGROUND

Utility users and utility providers typically monitor utility use by collecting data from one or more utility meters at users' premises. In some meter-reading systems, meters equipped with transmitters, such as radio-based transmitter modules, transmit meter-reading data locally to a data collection device (“CCU”). So that the collected data may be processed in a meaningful way, the CCU may periodically upload data to one or more host or “head-end” processors via a communication link, such as a wide-area network (WAN) or the Internet. In this way, information from thousands or even millions of meters and field collection devices can be gathered and processed in one or more centralized locations.

Past systems have sometimes used broadcast-style RF systems and similar systems to transmit collected data as needed. To facilitate communication in such systems, protocols are typically established that allow devices to communicate effectively among each other. Typically, these protocols are closely associated with the particular types of data being communicated. For example, in the past, some fixed-network meter-reading systems have used customized DNP (Distributed Network Protocol) messaging formats. However, DNP messages are sometimes large, difficult to read, and complex to parse. For example, thousands of CCUs may be transmitting large amounts of data to a single head-end system every hour, on the hour. In this and similar situations, messages formatted using DNP or similar standard protocols are sometimes too verbose for efficient transmission and processing.

Additionally, as meter-reading systems may change (e.g., be modified and/or upgraded to expand functionality and scope) data types used in the system may change. Data records associated with the changed data types, which are transmitted between devices, may also change. Because the protocols used to transmit the information may be linked to the type of data being transmitted, adding or changing data types in the system due to upgrades may require similar protocol changes. DNP does not have built-in versioning capabilities. Instead, new attribute/value pairs must be created to handle new information.

Once the collected data reaches the head-end, the processing of this large amount of information may be time-consuming, as the head-end system may conduct frequent periodic uploads (e.g., hourly) of a wide range of data types from a large number of meters. For large networks, such as large automatic meter-reading networks, there is a potential that the head-end system will consume millions of data elements several times per day.

### BRIEF DESCRIPTION OF THE DRAWINGS

FIG. 1 is a block diagram showing an example of a system on which one embodiment of a data collection and processing scheme may be implemented.

FIG. 2 is a block diagram showing an example of a message processing facility operating in the data collection system of FIG. 1.

FIG. 3 is a block diagram showing a class representation of various examples of data-specific packet processors for use in the facility of FIG. 2.

FIG. 4 is an example of a message data structure for use in the facility of FIG. 2.

FIG. 5 is a communication flow chart showing an example of a bulk data transfer in the facility of FIG. 2.

FIG. 6 is a flow chart showing an example of a routine performed at the message organizer for validating a received message in the facility of FIG. 2.

FIG. 7 is a flow chart illustrating an example of a routine for validating a received message, as initiated from the routine of FIG. 6.

FIG. 8 is a flow chart illustrating an example of a routine for processing of a received message, as initiated from the routine of FIG. 6.

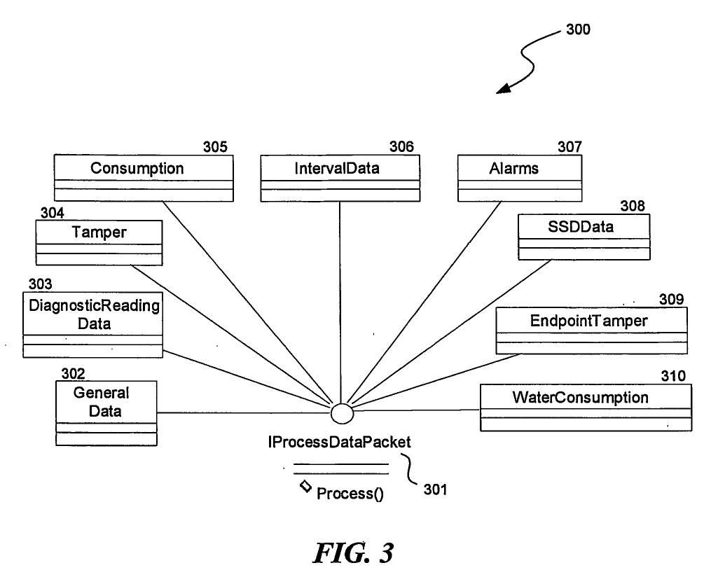

In the drawings, the same reference numbers identify identical or substantially similar elements or acts. To easily identify the discussion of any particular element or act, the most significant digit or digits in a reference number refer to the Figure number in which that element is first introduced (e.g., element 304 is first introduced and discussed with respect to FIG. 3).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The headings provided herein are for convenience only and do not necessarily affect the scope or meaning of the claimed invention.

It is intended that the terminology used in the description presented below be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A protocol, associated data model, and processing scheme (“data collection and processing system” or “system”) is used to facilitate data collection and processing and provides flexibility, compactness, and controllability.

In some embodiments, the data collection and processing system includes one or more CCUs that collect data from meters equipped with transmitters, such as encoder receiver/transmitter modules (“ERTs”). The CCUs then provide this data to a head-end system (“head-end”), so that the data can be processed as needed.

In some embodiments, the data collection and processing system handles data in binary form, which means that data items transmitted between the CCUs and the head-end are as small as possible. The data collection and processing system may support changes in system hardware and software, including changing data structures, without having to abandon older implementations. For example, a processor at the head-end can be configured to receive data from both CCUs running on a new software version and CCUs running older software versions. This allows the system to be upgraded over an extended period of time, rather than all at one time.

The data collection and processing system may provide features such as encryption using public key cryptography, compression of data packets, and packet information validation (error detection/correction). In some embodiments, the compression and validations steps can be combined. For example, compression using the known Gzip process may be used to perform a first step of validation, where a failed gunzip process will indicate a checksum problem.

In one embodiment, the data collection and processing system uses a message data structure (or “message”) as one of its high-level data types to send data between the CCUs and the head-end. For transmission, the message is encapsulated in an HTTP or HTTPS (HTTPS is a secure version of HTTP, which implements SSL) wrapper to take advantage of standard features associated with these protocols. The message data structure may be expandable and flexible and may allow for a large payload with respect to overall message size. The message structure itself may be recursive, which may allow for messages within messages and packets within messages. A header associated with a message can provide information about the type of message and other data concerning the message. A header associated with a packet can also include signature information that provides information about the data inside that packet.

By allowing messages to contain both packets and other messages, a single message can contain multiple data types or data formats, which provides for even greater efficiency. In addition, the message data structure makes it easy for the processors at the head-end to efficiently strip packets and messages apart at the head-end, while keeping the non-payload portions of the message (e.g., header, source, and processing information) at a minimum.

The data collection and processing system may provide multiple specialized processors that allow for asynchronous processing of large amounts of data having different types. For example, a message organizer component at the head-end can be configured to delegate data in need of processing to multiple specialized processors. In some embodiments, the data collection and processing system may allow for the addition of new processors without having to recompile the entire system.

Because of its flexibility, the data collection and processing system can also handle messages containing multiple data types, including relayed information (information transmitted to one CCU from another CCU).

The data within the data collection and processing system may include: data uploaded from the CCUs to the head-end (e.g., consumption data, tamper data, alarm data, etc.), data downloaded from the head-end to the CCUs (e.g., commands, call-in schedules). These categories may be further broken down and identified into specific data types (e.g., general consumption data, interval data, diagnostic data, alarm data, tamper data, etc.), each being transmitted in its own packet.

The first field of both message headers and packet headers may contain a signature. The signature field allows parsers at the head-end to figure out how to handle the message and facilitates both content and version control of the packet information. For example, a tamper message generated using a first version of software may have a different signature than a tamper message generated using a second software version.

II. System Architecture

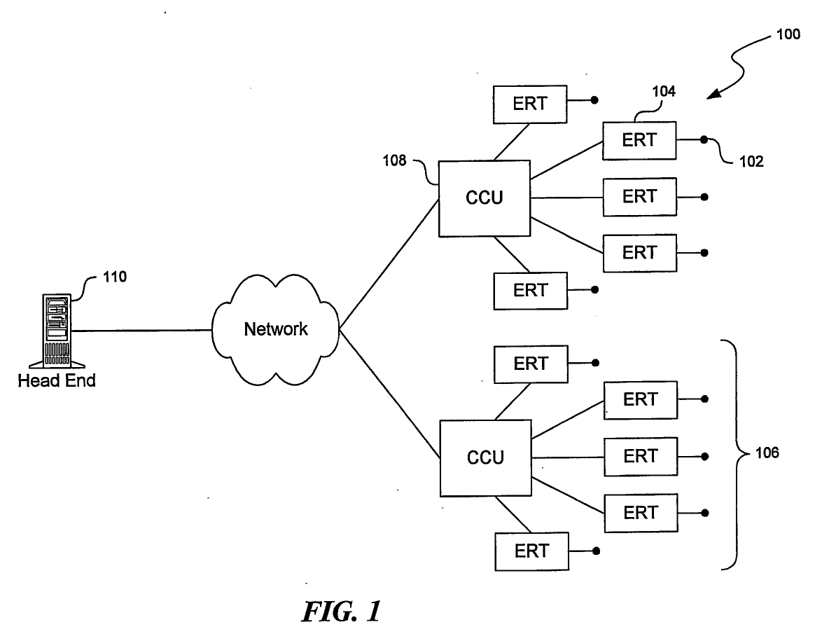

FIG. 1 and the following discussion provide a brief, general description of a suitable computing environment in which the invention can be implemented. Although not required, aspects of the invention are described in the general context of computer-executable instructions, such as routines executed by a general-purpose computer (e.g., a server computer, wireless device, or personal computer). Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer” are generally used interchangeably, and refer to any of the above devices and systems, as well as any data processor. Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network. In a distributed computing environment, program modules may be located in both local and remote memory storage devices.

Aspects of the invention may be stored or distributed on computer-readable media, including magnetically or optically readable computer discs, as microcode on semiconductor memory, nanotechnology memory, or other portable data storage medium. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer, such as a mobile device.

Referring to FIG. 1, a suitable system 100 on which the data collection and processing scheme may be implemented includes a meter-reading data collection system having multiple meters 102 coupled to utility-consuming devices (not shown), such as electric-, gas-, or water-consuming devices. In the illustrated embodiment, each meter 102 includes a radio transceiver module (ERT) 104, which serves as a data collection endpoint. The ERTs 104 encode consumption, tamper information, and other data from the meters 102 and communicate such information to a CCU device 108. The communication of this data may be accomplished via radio-to-radio data collection systems, such as hand-held, mobile automatic meter reading or fixed network. The ERTs 104 can be retrofitted to existing meters or installed on new meters during the manufacturing process. In a system for electrical metering, the ERTs 104 may be installed under the glass of new or existing electric meters 102 and are powered by electricity running to the meter. Gas and water ERTs 104 can be attached to the meter 102 and powered by long-life batteries.

As shown in FIG. 1, a group of ERTs 106 communicates with one of the CCUs 108, which in turn feeds collected data to a head-end system 110 via periodic uploads. This may occur on an ongoing basis (e.g., every half-hour) or as otherwise needed. The CCUs 108 may be implemented as neighborhood concentrators that read the ERTs 104, process data into a variety of applications, store data temporarily, and transport data to the head-end system 110 as needed. In some embodiments, the CCUs 108 can be installed on power poles or street light arms (not shown).

Further details about the system of FIG. 1, and similar systems can be found in the following commonly assigned patent applications: U.S. patent application Ser. No. 09/911,840, entitled “Spread Spectrum Meter Reading System Utilizing Low-speed/High-power Frequency Hopping,” filed Jul. 23, 2001, U.S. patent application Ser. No. 09/960,800, entitled “Radio Communication Network for Collecting Data From Utility Meters,” filed Sep. 21, 2001, and U.S. patent application Ser. No. 10/024,977, entitled “Wide Area Communications Network for Remote Data Generating Stations,” filed Dec. 19, 2001, which are herein incorporated by reference.

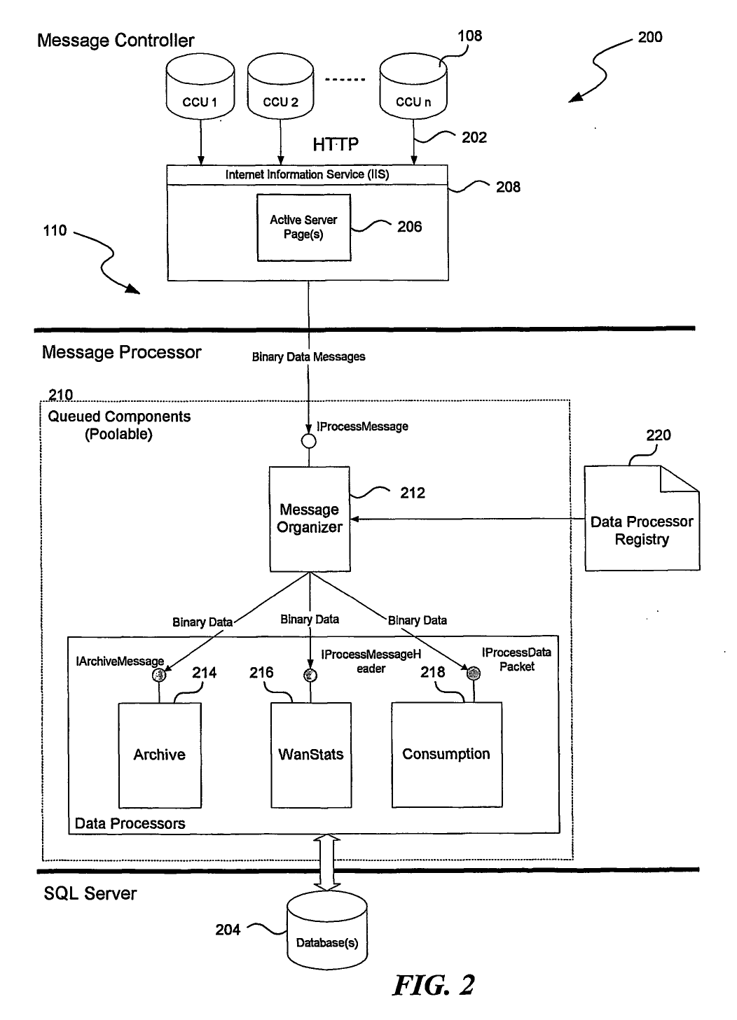

Referring to FIG. 2, a message processing facility 200 operating in the data collection system of FIG. 1 is shown. The message processing facility 200 may operate primarily within the head-end system 110. The message processing facility may be hardware-based, embodied in software in a computer-readable medium, or any combination of the two. Components making up the message processing facility may be “configured” components, meaning that they “live” in an application such as a Microsoft COM+ application.

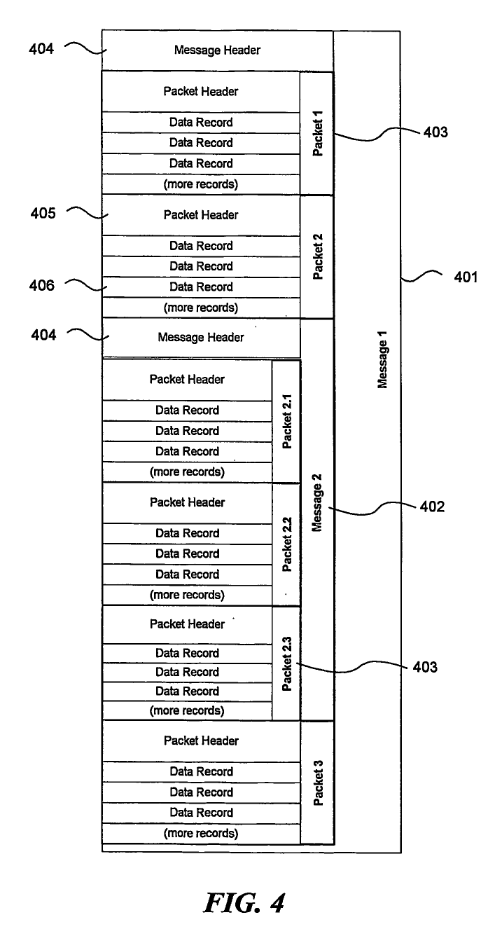

The message processing facility 200 may receive data in messages (“messages”) from CCUs 108 via a communication link 202 using an application layer protocol such as HTTP, HTTPS, WAP, SMTP, FTP, etc. The messages may be comprised entirely of the binary data payload being sent. In some embodiments, to increase efficiency, the messages may omit any separators, variable names, or other information. In addition to the payload, headers may be incorporated into the messages, as described in more detail with respect to FIG. 4.

The message processing facility 200 allows data to be stored in a database 204, such as an SQL Server database. In the illustrated embodiment, the message processing facility 200 uses an Active Server Page (ASP) 206 running on an Internet Information Service (IIS) component 208 to accept the data message from the CCU 108 and in turn, hand that message off to a message processor 210 after performing functions, such as validating the integrity of the message. More than one ASP page 206 can be used to handle different types of messages. For example, for regular uploads, the CCU 108 can target an upload ASP page 206 to post binary data, while for critical alarms, the CCU 108 can target a different ASP page 206 to post alarm data. This allows messages having more time-sensitive information to be given higher processing priority within the system. For example, the critical alarm could be put onto a separate web site or web server with different throttling or loading characteristics than the regular uploads to ensure timely delivery. There may be additional ASP pages 206 that service other specific CCU 108 needs, such as a request for configuration information without posted data.

The ASP page 206 may receive message headers (e.g., HTTPS headers) through, for example, a ServerVariables collection (not shown) and may receive binary payload data through, for example, a RequestBinaryRead method (not shown). Binary data is returned to the ASP page as a SafeArray of unsigned bytes (VT₁₃ ARRAY | VT₁₃ UI1). This information can then be passed to a ValidateGzip component (not shown), which writes the data as a temporary file on a file system (not shown). The ValidateGzip component can in turn use, for example, a Dynazip-GT ActiveX control (instantiated as an in-process server) to validate the file. The ValidateGzip component can return an appropriate status code upon success or failure of the validation, and may log any failures and/or warnings to an event log.

The ASP page communicates data to a message organizer component 212 of the message processor 210. As with other components within the message processor 210, the message organizer component 212 may be configured as a “queued component” (e.g., Microsoft COM+ queued components), so that calls to it by the ASP page 206 are asynchronous, allowing the ASP page 206 to continue processing of other messages immediately. With queuing enabled, the components of the message processing facility 200, including the message organizer 212, can be reached via message queues (not shown). While a component within the message processing facility 200 may be referred to here as a “queued component,” it may actually be interfaces on the component marked as “queued.” In some embodiments, it is possible for some interfaces to be queued and others not. As an alternative to queued components, other implementation techniques may be used, such as interface-based implementations, (e.g., Microsoft net), procedural-based implementations, Java- or Java bean-based implementations, etc. Additionally, the message processing facility's 200 queued and/or pooled components may be “stateless,” meaning that the components do not depend on or store any information from previous invocations.

In the illustrated embodiment, the message organizer 212 archives received data using an archive sub-component 214. In some cases, the received data may need to be decompressed using a tool such as DynaZip (not shown). The message organizer 212 may also have a WanStats sub-component 216, which extracts WAN statistics from message headers and HTTP or HTTPS header data, etc. Aside from the archive 214 and WanStats 216 processing components, one or more specialized packet processors 218 do much of the processing work for the message organizer 212 in the illustrated embodiment. The message organizer 212 coordinates the activities of the one or more packet processors 218. For example, in some embodiments, the message organizer 212 is responsible for delegating received data to the proper packet processor 218 to put in the database 204.

In the illustrated embodiment, each packet processor 218 is configured to process a particular kind of data. For clarity, a consumption data processor 218 is the only data packet processor shown in FIG. 2. Examples of other types of packet processors are shown in FIG. 3 (described below).

A data processor registry 220 having registry keys configures the message processing facility 200 and determines how information used by the message processing facility is organized. In the illustrated embodiment, each registry key in the registry 220 may correspond to a component or sub-component in the message processing facility. For example, to help identify the various data packet processors, the message organizer 212 may rely on a DataPacketProcessors key that contains a series of subkeys, each of which describes a specific data packet processor. Likewise, a ProgID value under each subkey can be used to indicate, for example, the COM ProgID by which the specific processor can be invoked.

The use of the registry 220 allows the message organizer 212 to be easily reconfigured to handle new kinds of data. For example, adding a new kind of data may simply involve creating a new data packet processor, installing it on the server, and adding its information to the registry.

Referring to FIG. 3, a class representation 300 of various examples of data-specific packet processors, such as for processing utility meter-reading data, is shown. While the specific packet processors represented in this diagram may handle data types that are specific to meter-reading systems, other packet processor types may be used in other systems having different types of data without departing from the scope of the invention.

In the illustrated embodiment, the represented packet processor classes relate back to a common IProcessDataPacket interface class 301. A GeneralData class 302 represents a processor responsible for handling arbitrary binary data sent from a CCU to the head-end, normally as the result of a diagnostic request. A DiagnosticReadingData class 303 represents a packet processor responsible for handling, for example, ERT diagnostic data. A Tamper class 304 represents a packet processor for handling data that provides an indication that a system component (e.g., ERT, etc.) has been physically or otherwise tampered with.

A Consumption class 305 represents a packet processor for handling data representing consumption of a utility by a metered device. An IntervalData class 306 represents a packet processor responsible for handling interval data. An Alarms class 307 represents a packet processor responsible for handling alarm data (e.g., data about outages, low battery power, temperature problems, etc.). An SSDData class 308 represents a packet processor responsible for handling interval data coming from ERTs employing solid state demand techniques. An EndpointTamper class 309 represents a packet processor responsible for handling tamper data generated by system endpoints. A WaterConsumption class 310 represents a packet processor responsible for handling consumption and leak detection data for a water meter.

III. Message Structure

The system may be implemented using a variety of data types or record types that can be transmitted between the CCU and the head-end. For efficiency, in some embodiments, the data may be byte-packed—meaning there is no padding added for byte-alignment purposes.

Referring to FIG. 4, a message data structure 401 facilitates transmitting messages between the CCU and head-end. The message data structure 401 can contain zero or more recursive-style messages 402 (i.e., messages within messages) and zero or more packets 403. For example, the message 401 in the illustrated embodiment contains one recursive style message 402 and three packets 403 (Packets 1-3). The recursive-style message 402 in the illustrated embodiment also contains three of its own packets 403 (packets 2.1-2.3). Each message (401 and 402) includes a message header 404. In the illustrated embodiment, each packet 403 also includes a packet header 405, followed by one or more data records 406. The packet header 405 identifies the type of data contained in the packet. In some embodiments, each packet 403 contains data records 406 of only one data type. For example, a packet 403 that contains alarm data records will not contain consumption data records. In some embodiments, where a packet contains multiple data records 406, each data record may correspond to a specific ERT module in communication with the CCU sending the message 401. Accordingly, each data record 406 may include an ERT identifier (not shown).

Each message (401 and 402) may include a message header 404 for identification. An example of information contained in a message header 404 is shown below in Table 1.

TABLE 1
Message Header Fields

| Field Name | Type | Description |
|---|---|---|
| Message | SIGNATURE | Message Identifier |
| Signature | | |
| Message Length | DWORD | Length of entire message, including |
| | | header in bytes (does include the |
| | | length of the Message Signature) |
| Number of Items | DWORD | Number of data packets and messages |
| | | in message |
| Device ID | DWORD | ID of CCU associated with the data |
| Device Type | BYTE | Type of CCU associated with the data |
| UTC Date Time | DATETIME | UTC time message was constructed |

In the illustrated embodiment, the messages do not contain information about encryption or compression, as it is assumed that this will be handled at a higher level in the system. For example, most encryption and compression utilities use their own headers; once the message is decrypted and/or decompressed these headers are discarded. However, in alternate embodiments, the message structure may facilitate encryption or compression at the message level.

Packet headers 405 may be similar to message headers 404. The packet header 405 may identify the number and type of data records contained in each packet 403. The packet header 405 may also include a link to the packet header 405 for the next packet 403 in the message. An example of information contained in a packet header 405 is shown below in Table 2.

TABLE 2
Packet Header Fields

| Field Name | Type | Description |
|---|---|---|
| Packet Signature | SIGNATURE | Packet Signature |
| Packet Length | DWORD | Length of entire packet, including |
| | | header in bytes (does include the |
| | | length of the Packet Signature) |
| Record Signature | SIGNATURE | Signature of data records in this |
| | | packet |
| Number of Records | DWORD | Number of data records in packet |
| UTC Date Time | DATETIME | UTC time packet was constructed |

In the illustrated embodiment, each header includes a signature (not shown) that indicates the type of packet or message and its format. The purpose of the signature is to uniquely identify each message and record type passed between the head-end and the CCU. Because signatures are typically static within a system, a new header type and signature can be used to allow for changing data types in an evolving system. In this way, the head-end and/or CCU can pass data using mixed formats until such time as all the CCU software within the system has been updated. Examples of some of the signatures that can be used in the system are shown below in Table 3; of course, other signatures are possible. Some of these record/data types are described further in portions of the text that follow.

TABLE 3

| Signatures | |
|---|---|
| Record Type | Signature |
| MESSAGE_HEADER | 0x00000001 |
| PACKET_HEADER | 0x00000002 |
| SSD_READING_DATA | 0x00000003 |
| DIAG_READING_DATA | 0x00000004 |
| TAMPER_DATA | 0x00000005 |
| ALARM_DATA | 0x00000006 |
| CONF_CALLIN_SCHED | 0x00000007 |
| SW_DNLD_ROLLBACK | 0x00000008 |
| SW_DNLD_CANCEL | 0x00000009 |
| SW_DNLD_TAKE | 0x0000000A |
| CCU_REBOOT | 0x0000000B |
| CCU_RESET | 0x0000000C |
| PUBLIC_KEY | 0x0000000D |
| CCU_CONFIGURATION | 0x0000000E |
| SW_DNLD_CONFIGURATION | . . . |
| SW_DNLD_CMD_RESPONSE | . . . |
| CCU_CONFIGURATION_RESPONSE | . . . |
| SW_DNLD_DOWNLOAD | . . . |
| GENERAL_DATA | . . . |

When sending binary data, in some embodiments, both the head-end and CCU may compress the payload for a more efficient transfer. Examples of states for binary data may be Gzip compressed or uncompressed. Information about the Gzip standard is available at the Gzip home page (www.gzip.org). The sender of data may identify any compression using the HTTP header “Content-Encoding.”

IV. Data Transfer and Message Processing Flows

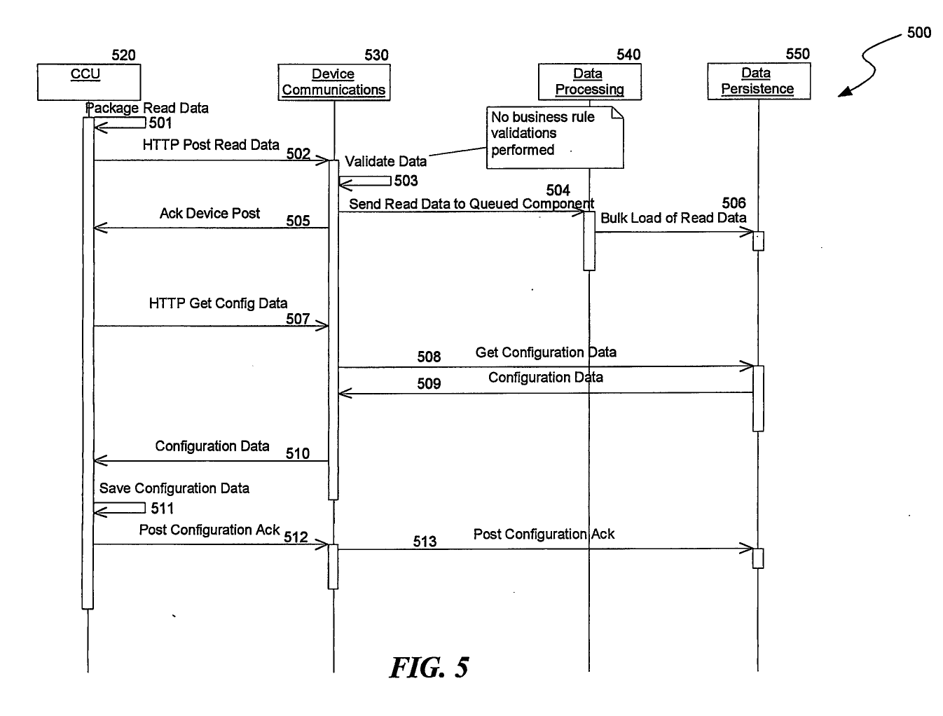

FIG. 5 is a communication flow 500 showing an example of a bulk data transfer flow in one embodiment. The communication occurs between a CCU device 520 and various processes at the head-end system, including a device communications process 530 (occurring at, for example, the IIS, ASP page, message organizer, etc.); a data processing process 540 (occurring at, for example, message organizer, packet processors, etc.); and a data persistence process 550 (occurring at, for example, file storage, database, etc.).

At process 501, the CCU 520 packages collect data into a message structure, such as the message structure of FIG. 4. At communication 502, the CCU 520 transmits the collected data to the device communications process 530. At process 503, the device communications process 530 validates the data. At communication 504, the device communications process 530 sends the validated data to the data processing process 540. At communication 505, the device communications process 530 sends an acknowledgment to the CCU 520. At communication 506, the data processing process 540 loads data to the data persistence process 550.

At communication 507, the CCU 520 sends a configuration request to the device communications process 530. At communication 508, the device communications process 530 retrieves configuration data from the data persistence process 550. At communication 509, the data persistence process 550 sends configuration data back to the device communications process 530, which prepares the data for transmittal to the CCU 520. At communication 510, the device communications process 530 sends the configuration data to the CCU 520. At process 511, the CCU 520 saves the configuration data. At communication 512, the CCU 520 sends an acknowledgment of receiving the configuration data to the device communications process 530. At communication 513, the device communications process posts the acknowledgment by sending it on to the data persistence process 550.

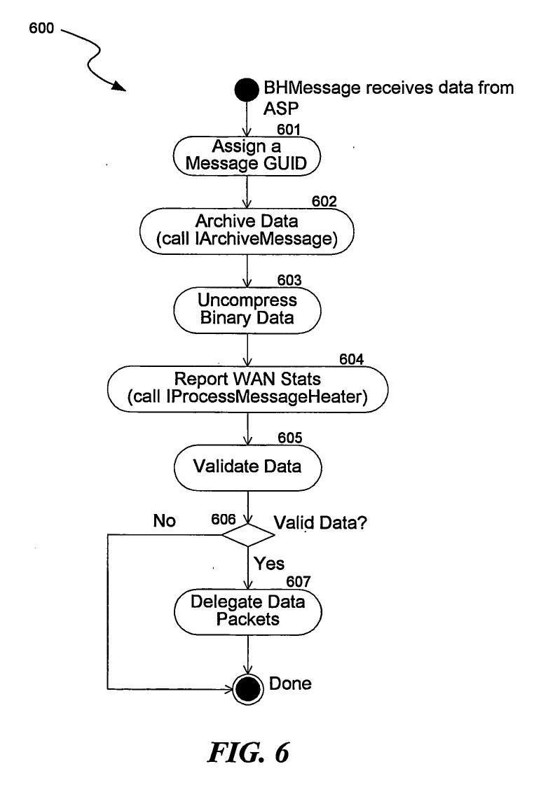

Referring to FIGS. 6 through 8, some functionality performed by the system of one embodiment of the present invention is shown as one or more routines.

FIG. 6 is a flow chart showing an example of a routine 600 performed at a message organizer 212 of FIG. 2. When an object-oriented implementation is used, the message organizer component may be configured for Just-In-Time (JIT) activation and object pooling so that each method call to the message organizer component will activate a new object. While parsing a message, if the message organizer component has a parsing error and the error is data-related, an error message may be logged and a “success” notification returned. If the error is unexpected (e.g., being unable to create an instance of a needed component), a “failed” notification may be returned.

At block 601 the routine assigns a global unique identifier for the message. At block 602 the routine calls an archive component, such as the archive sub-component 214 of FIG. 2, to archive the message. In the archive operation the archive component stores data messages in a permanent store (such as a database, a file, or both). In some embodiments, the archive operation returns a value depending on whether the archive operation was successful (e.g., 0 for success, nonzero for error).

At block 603 the routine uncompresses the binary data comprising the message using, for example, a known decompressing tool such as DynaZip to decompress the message's binary data. At block 604 the routine calls a WanStats component, such as the WAN/Stats sub-component 216 of FIG. 2, to report the WAN statistics for the message. At block 605 the routine validates the contents of the message. The contents may be partially validated by verifying the size of the message and the number of items contained in the message (described in more detail below). At decision block 606 if the data is valid (e.g., no errors are encountered), the routine continues at block 607, otherwise, the routine ends. At block 607 the routine delegates the received data packets to the appropriate data packet processors, such as the data packet processors 218 of FIG. 2.

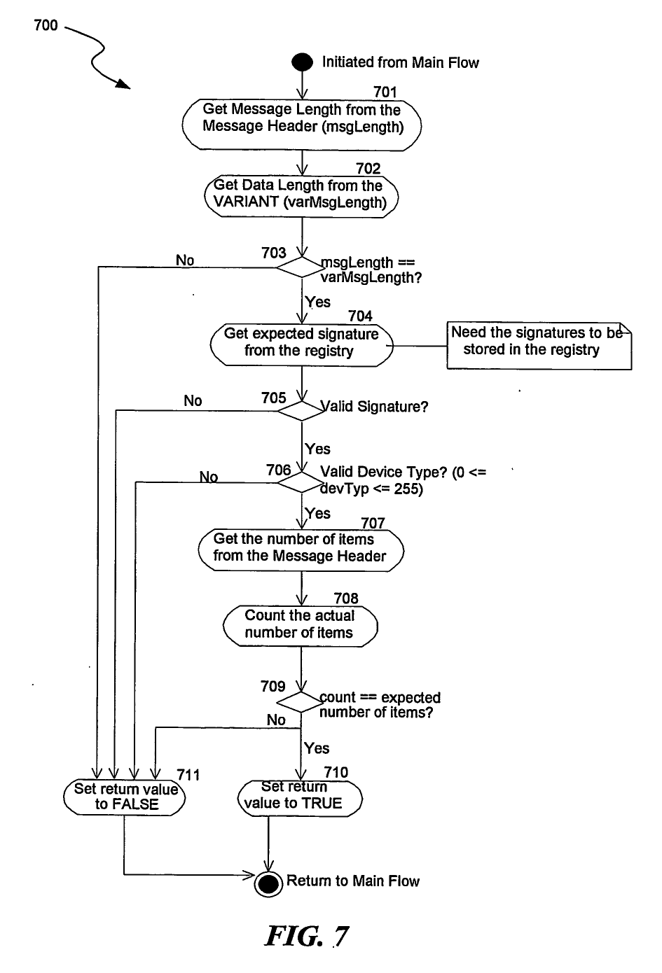

FIG. 7 illustrates a routine 700 for validating a received message, as initiated from block 605 of the routine 600 of FIG. 6. All or part of this routine 700 may be performed at the message organizer component. At block 701, the routine traverses the message to get the message length from the message header. At block 702, the routine gets a data length for the data in the message. In decision block 703 if the message length is valid, the routine continues at block 704. Otherwise, if at decision block 703 the message length is invalid, the routine proceeds to block 711 where the routine sets a return value to false (invalid message) before returning to the main flow of FIG. 6. At block 704, the routine gets a signature from the registry. At decision block 705, the routine checks to see if the signature for the message is valid. If the signature is valid, the routine continues at decision block 706. Otherwise, if at decision block 705 the signature is not valid, the routine proceeds to block 711 where the routine sets a return value to false (invalid message) before returning to the main flow of FIG. 6.

At decision block 706, the routine checks the device type from which the data was originated and proceeds at block 707 if the device type is valid. Otherwise, if at decision block 706 the device type is not valid, the routine proceeds to block 711 where the routine sets a return value to false (invalid message) before returning to the main flow of FIG. 6.

At block 707, the routine gets the number of items from the message header. At block 708, the routine counts the number of items in the message itself and proceeds to decision block 709. At decision block 709, if the message header item count matches the actual item count, the routine continues at block 710. Otherwise, if at decision block 709 the message header item count does not match the actual item count, the routine proceeds to block 711, where the routine sets a return value to false (invalid message) before returning to the main flow of FIG. 6. At block 710, the routine sets the return value to true and returns to the main flow of FIG. 6, at block 607.

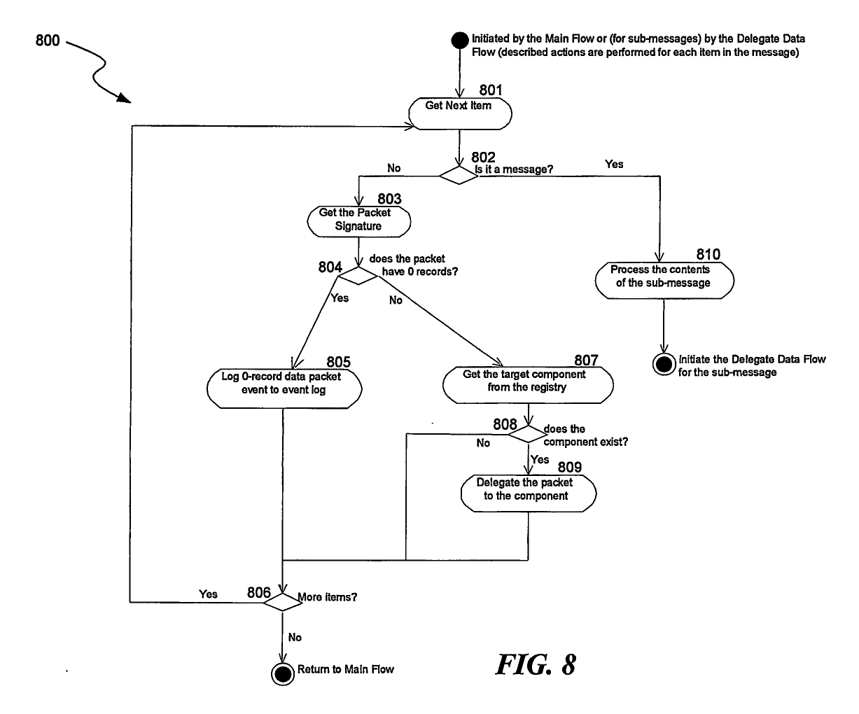

FIG. 8 illustrates a routine 800 for processing of a received message, as initiated from block 607 of the routine 600 of FIG. 6. Because the message structure may be recursive, the routine is also recursive, allowing the entire contents of the message to be processed. Various data processors, such as the data processors of FIG. 3, may be invoked in the processing of a single message. Each one of the data processors processes a specific type of packet and stores it in the database. A process operation may return a value that depends on whether the process operation was successful (e.g., returns 0 for success, nonzero for error).

At block 801, the routine retrieves the next item in the message. The item can either be another message or a packet. At decision block 802, if the item is another message, a recursive call is necessary and the routine continues at block 810, where the routine processes the contents of the sub-message by initiating the routine 800 of FIG. 8 for the next message. If, however, at decision block 802 the item is a packet, the routine continues at block 803, where the routine retrieves the packet signature.

Some data packets may be “empty,” meaning that they do not contain data records. The presence of empty packets may be logged to the Windows event log. Accordingly, at decision block 804, if the packet does not hold any records, the routine continues at block 805, where the routine creates a log and then proceeds to decision block 806. At decision block 806, if there are additional items in the packet, the routine loops back to block 801 to get the next item for processing. Otherwise, the routine returns to the main flow of FIG. 6.

If at decision block 804 the routine has records, meaning there is data to be processed, the routine continues at block 807, where the routine does a registry look-up to find the target component that matches the data type in the packet. In some embodiments, worker components (e.g., WanStats and Archive) may be invoked for a program logic-type registry look-up, as opposed to a simple look-up for a matching component. A registry key with ProgID may be utilized for this function. If the registry contains invalid processor information and an element corresponding to the invalid information is found in a CCU message, the message organizer component may reject the document and log an error message.

At decision block 808, if the target component does not exist, then the routine proceeds to decision block 806 to check for more items. Otherwise, at decision block 808, if the component exists, the routine continues at block 809 where the packet is delegated to the looked-up component and continues at block 806 to check for more items.

Like the message organizer, each delegated data packet processor may be a queued component, allowing asynchronous processing of each type of data. It sends each data packet processor just the data packet it is designed to process, not the entire message. If there are multiple data packets of the same type in a single message, the matching component will be called multiple times. Because the data packet processing may be asynchronous, each processor may create its own subsequent transactions based on the processed message.

In some embodiments, if a message contains two or more data packets, it is possible for one of the packets to successfully post its data to the database while the others fail. When a data packet hands its data off to the database server, the database server may wrap the data in a transaction depending on the data packet. It may be the database server's responsibility (or a stored procedure's responsibility) to roll back or commit the data. When the database server has a problem processing the data, an appropriate notification may be returned to the component. The component can then inspect the notification to determine what should be done. Since the data packet processors, as well as the message organizer component, may all be queued components, when one of the packet processors has an unexpected problem (nondata-related), it may return a failure notification to the caller (the queued component subsystem), which causes the call to be requeued. In some embodiments, the failure notification may only be returned when the data appears to be valid but normal processing is interrupted. For example, the processor may return a failure notification, if the processor could not obtain a resource or if the database server is down. In the event of bad data, an appropriate error may be logged, the message written to file, and a successful notification returned so that the call is not requeued. The processors may also return a failed notification in cases, where the data is good but processing could not complete because of an unexpected problem, such as the unavailability of the database server or the inability to load a component. In general, data packet processors insert the binary data into the database and conduct other processing tasks. For example, the Packet Processor for alarm processing could queue alarms to be sent directly to an alarm processing system in addition to storing the data in the database. Also, the packet processors could provide data translation (modification of the data for some application purpose) prior to inserting into the database.

In some cases, post-processing may be implemented once binary data is inserted into the database. Naming conventions for data types may be adopted in order to facilitate this process.

Like the message organizer, the specific data packet processor components may also be configured for JIT activation and object pooling so that each method call to the components will activate a new object.

V. Sample Data Configurations

The system described above can collect and process various types of data, such as data associated with utility meter reading. Examples of these types of data are described below. Of course, other types of data or combinations of data may be employed in different systems, such as those unrelated to meter reading.

Consumption Data

As described with respect to FIG. 1, CCUs collect consumption data from ERT units on an ongoing basis. To facilitate transmission of data to the head-end, consumption data collected from an ERT may be grouped into a scan period (e.g., one hour). CCUs may collect many different types of consumption data, such as data in standard consumption message (SCM) format, data in interval data message (IDM) format, and data from ERT units employing solid state demand (SSD) techniques. SCM messages contain simple accumulative consumption and tamper data. IDM messages include SCM data along with a stream of interval data (consumption deltas or differential consumption, where each interval measures consumption over a fixed period of time) and associated interval data status information indicating the validity (e.g., based on outage occurrences, overflow situations, etc.) of the associated intervals. SSD messages contain IDM data plus additional register information obtained directly from the associated solid state demand meter. These additional registers may be stored in billing determinate and/or meter status fields and generally contain a consumption reading, a demand reading, and a demand reset date/time for when the last demand reset occurred.

The type of consumption data being collected may affect the packaging of the data into packets and messages at the CCU. For example, during a scan period, the CCU may receive SCM communications from some ERTs more than once. When this occurs, the CCU stores the last SCM reading from the scan period. Accordingly, for each ERT in communication with the CCU, the CCU stores and forwards one consumption reading at a time, if received, per ERT per scan period. The consumption readings are sent most recent consumption data first.

With IDM data, the CCU stores and forwards the last consumption reading received and all IDM intervals since the last successful upload to the head-end. The CCU receives the same IDM intervals multiple times; however, the CCU resolves the redundancy and forwards each IDM interval once. Deltas are sent with the most recent delta sent first. When an outage occurs, the CCU packages existing intervals and then creates a new package for intervals after the outage. When the outage period is less than the elapsed time normally covered by an IDM interval message, the CCU creates a third package. The third package contains the intervals that occurred prior to the outage but after the CCU received the last IDM message. The first interval following the power restoration is marked with an outage status.

With SSD data, the CCU stores and forwards the last consumption reading, billing determinants, and meter statuses received. The CCU receives the same SSD intervals multiple times; however, the CCU forwards each SSD interval once. Deltas are sent with the most recent delta sent first. When an outage occurs, the CCU packages existing intervals and then creates a new package for intervals after the outage. When the outage period is less than the elapsed time normally covered by an SSD interval message, the CCU creates a third package. The third package contains the intervals that occurred prior to the outage but after the CCU received the last SSD interval message. The first interval following the power restoration is marked with an outage status.

In some embodiments, there is a limit to the number of data blocks that can be stored in a single data record. In order to support such limitations, the CCUs may be configured to package reading data for delivery on a frequent period basis (e.g., once every 24 hours).

Tamper and Alarm Data

When a tamper condition occurs at an ERT or CCU, the CCU may record the tamper and send the data at the scheduled time. Where the system can distinguish between different types of tampering, a full set of tamper indicators and counters may be sent for each of the multiple possible tamper conditions.

Alarm conditions may be treated slightly differently from tamper conditions. There may be more than one type of alarm, such as alarms that represent a one-time event (event alarms) and alarms that represent a condition that spans a period of time (duration alarms). When a condition represented by a duration alarm begins, an event record is created indicating a start time and value. When it ends, a second event record is created indicating the end time and value. Ending event records contain the start values so that they can be correlated with the starting event record. An alarm may also be given a priority level (time critical, time not critical, etc.). Critical alarms may be delivered immediately, while noncritical alarms may be delivered during a next scheduled alarm upload. Examples of different alarm conditions are shown below in Table 4.

TABLE 4
Alarm Conditions

| | Priority | Event or | |
|---|---|---|---|
| Alarm Name | (Default) | Duration | Description |
| CCU outage | critical | Event | CCU power outage |
| CCU restoration | critical | Duration | CCU restoration |
| | | | Alarm Start Value is set to time that |
| | | | outage occurred |
| | | | Alarm end time is set to time that |
| | | | restoration occurs |
| CCU | noncritical | Event | CCU instantaneous power outage |
| instantaneous | | | |
| power outage | | | |
| CCU scheduled | noncritical | Event | Scheduled-for reboot |
| reboot | | | |
| CCU unscheduled | noncritical | Event | Alarm value set by application diagnostics |
| reboot | | | |
| Security breach | noncritical | Event | |
| Battery low | noncritical | Event | |
| Battery dying | noncritical | Event | |
| Network | noncritical | Event | |
| communication | | | |
| failure | | | |
| Message failed | noncritical | Event | Head-end rejects message 3 times |
| validation | | | during one communication session |
| Message rolled off | noncritical | Event | CCU deletes message after failing |
| | | | to transmit for 3 days |
| ERT restore alarm | noncritical | Event | Alarm when ERT restores |

Communications from Head-End to CCU

The head-end may use HTTP or HTTPS status codes to communicate status to the CCU when the CCU is posting or sending out data. Some examples of status codes are shown in Table 5.

TABLE 5
Status Codes

| Status Code | |
|---|---|
| Name | Description |
| Stop | Stop sending bulk data; send at next scheduled upload |
| Continue | Continue sending upload data |
| Stop & Flush | Stop sending bulk data; flush any data already packaged for |
| | upload |
| Okay | Data received okay |
| Error | Error receiving data; retry upload. After third upload |
| | attempt in the same session, the CCU sends the next |
| | message. The CCU tries to upload the message |
| | during the next communication session. The CCU |
| | deletes the message when transmission is |
| | successful or three days pass. |

Configuration Data from Head-End to CCU

Configuration messages sent from the head-end may be used to control configuration of the CCU. A new configuration at the CCU takes effect when the CCU receives a configuration message from the head-end. Upon receipt of such a message, the CCU saves current data and then activates the new configuration.

Configuration data can be linked to a global unique identifier (GUID) that uniquely identifies a set of configuration data. Accordingly, one of the data packets in the configuration data set may be a GUID packet that defines the GUID associated with the set. The CCU sends a configuration request indicating the GUID of the configuration set currently active in the CCU; if the head-end detects that there is a new configuration data set available, then it will send the new data. In turn, the CCU will validate the new data and send back a CCU configuration response.

The configuration response may contain the GUID of the configuration data set, the number of errors, and error data including the signature of the offending data packet, a result code, and a status code. If the GUID packet was not found, the CCU may return a null GUID (e.g., all zeros). If the entire message was corrupted, the error signature will be that of the message header. If the CCU sees a signature value that it does not understand, it will generate an error that includes the invalid signature.

Call-In Schedules

Call-in schedules can be provided to a CCU to control non-event driven communications, or scheduled communications, to the head-end. Such communications may include, for example, data delivery (upload), configuration information download, and software download. Accordingly, the CCU typically sends data only when it is scheduled to do so by the head-end via the call-in schedule. However, there are instances when the CCU can asynchronously deliver data based on an event. For example, high priority alarms can be delivered outside of the call-in schedule. So there are two types of communication—event driven (high priority alarms) and non-event driven (scheduled via the call-in schedule).

Call-in schedules are transmitted to the CCU during a configuration session. To allow for dynamic call-in schedules without requiring all configuration data to be re-sent, call-in schedules may be implemented without GUIDs. In some embodiments, the head-end sends a current call-in schedule every time the CCU requests configuration. In some embodiments, the following rules for call-in schedules apply:
If nothing changes at the head-end except the call-in schedule, only the call-in schedule may be sent.
If both the call-in schedule and a configuration data set is sent and any part of either fails CCU validation, the CCU may reject both. The CCU may return a configuration response rejecting the configuration set. The configuration response may contain the GUID of the new configuration set.
If only the call-in schedule is sent and it fails CCU validation, then the CCU may return a configuration response containing a null GUID (all zeros) indicating the reason for the rejection. The error signature may be that of the call-in schedule. This allows for distinguishing between this condition and corruption of an entire message.

In some embodiments, the CCU handles duplicate command messages in an intelligent manner as a safeguard in the case where messages are lost. An example of this is if the CCU received a duplicate download command and it was in the process of downloading the software packages or had already completed the download. In this case, the CCU may respond with a command accepted ACK instead of initiating the operation again.

Software Download Messages

Special message types may be used for software downloads (described further in application Ser. No. ______, attorney docket no. 10145-8011). In some embodiments, the software download conversation between head-end and CCU is in four parts. First, the CCU posts a request message that contains a software download configuration request packet and an optional software download command response packet. Second, the head-end responds with a status code, a software download configuration response packet, and any command packets as may be appropriate. Third, the CCU posts an acknowledgment message with a software download configuration request packet and a software download command response packet. Fourth, the head-end responds with a status code. The second and fourth parts relating to status codes occur when the messages sent between the head-end and the CCU are encapsulated in HTTP or HTTPS wrappers

A software download configuration message may be used both as a CCU to head-end request and a head-end to CCU response. The message may contain a list of GUIDs that describe the CCU's current software bill of materials (BOM). The configuration message may include a list of GUIDs that describe the next version of software. If either list of GUIDs is empty, a “Number of GUIDs” field may contain 0. When used as a CCU request, the message may describe the CCU's configuration. When used as a head-end response, the message may describe the head-end's view of the CCU software configuration. Examples of the fields of the software download configuration request/response message are shown below in Table 6.

TABLE 6
Configuration Request/Response

| Field Name | Description |
|---|---|
| Signature | Identifier for this record type |
| Data Length | Actual size of data record (includes the |
| | length of the signature) |
| Device ID | CCU ID |
| Device Type | CCU type |
| Number of “current” GUIDs | Number of GUIDs describing current |
| | software BOM |
| Software Type | Type of software described by the GUID |
| Software GUID | GUID identifying the software component |
| Number of “next” GUIDs | Number of GUIDs describing next |
| | software BOM |
| Software Type | Type of software described by the GUID |
| Software GUID | GUID identifying the software component |

To facilitate software download, the head-end may send a variety of software download command messages, including messages instructing a CCU to download software, providing a CCU with a “take effect time” for a version of software, instructing a CCU to roll back to a previous version of software, instructing a CCU to cancel software download, etc. Examples of the fields contained in such command messages are shown in tables 7 through 10.

TABLE 7
Software Download Command Message Fields

| Field Name | Type | Description |
|---|---|---|
| Signature | SIGNATURE | Identifier for this record type |
| Data Length | WORD | Actual size of data record (does |
| | | include the length of the signature) |
| Device ID | DWORD | CCU ID |
| Device Type | BYTE | CCU type |
| Number of GUIDs | BYTE | Number of GUIDs describing the |
| | | software BOM |
| Software Type | UTF-8(4) | Type of software described by the |
| | | GUID |
| Software GUID | BINARY(16) | GUID identifying the software |
| | | component |

TABLE 8
Take Effect Command Message Fields

| Field Name | Type | Description |
|---|---|---|
| Signature | SIGNATURE | Identifier for this record type |
| Data Length | WORD | Actual size of data record (does |
| | | include the length of the signature) |
| Device ID | DWORD | CCU ID |
| Device Type | BYTE | CCU type |
| Number of | BYTE | Number of GUIDs describing next |
| GUIDs | | software BOM |
| Software Type | UTF-8 | Type of software described by the |
| | | GUID |
| Software GUID | BINARY | GUID identifying the software |
| | | component |
| UTC Take-Effect | DATETIME | Valid DATETIME - Time the new |
| Time | | software is to be installed and |
| | | become current |
| | | 0 = Immediate Take Effect (upon |
| | | receipt of the message or completion |
| | | of the software BOM download) |

TABLE 9
Cancel Command Message Fields

| Field Name | Type | Description |
|---|---|---|
| Signature | SIGNATURE | Identifier for this record type |
| Data Length | WORD | Actual size of data record (does |
| | | include the length of the signature) |
| Device ID | DWORD | CCU ID |
| Device Type | BYTE | CCU type |
| Number of GUIDs | BYTE | Number of GUIDs describing the |
| | | software BOM to Cancel |
| Software Type | UTF-8 | Type of software described by the |
| | | GUID |
| Software GUID | BINARY | GUID identifying the software |
| | | component |

TABLE 10
Rollback Command Message Fields

| Field Name | Type | Description |
|---|---|---|
| Signature | SIGNATURE | Identifier for this record type |
| Data Length | WORD | Actual size of data record (does |
| | | include the length of the signature) |
| Device ID | DWORD | CCU ID |
| Device Type | BYTE | CCU type |
| Number of GUIDs | BYTE | Number of GUIDs describing the |
| | | software BOM to Cancel |
| Software Type | UTF-8 | Type of software described by the |
| | | GUID |
| Software GUID | BINARY | GUID identifying the software |
| | | component |

The CCU may use software download command response messages to acknowledge either the receipt or execution of a software download command message, such as those shown in Tables 7 through 10. Acknowledgment received in response to a command may signify that the CCU has accepted the command and will act on it. However, in some embodiments, it may not signify the successful completion of the command. In such cases, the CCU will return a second command response message indicating the results of executing the command. A failed command execution response message may include information describing the failure. Such a command response message may be appended to a configuration request message sent during the conversation, instead of being appended to the second configuration request/command response reply sent in response to the head-end's configuration response message. An example of a situation resulting in a command reject would be a request to roll back to a version not present on the CCU. An example of a situation resulting in a failed execution of a command is a failed attempt to roll back to a previous software version.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the automatic meter-reading system described herein. The elements and acts of the various embodiments described above can be combined to provide further embodiments and some steps may be deleted, moved, added, subdivided, combined, and/or modified. Each of these steps may be implemented in a variety of different ways. Also, while these steps are shown as being performed in series, these steps may instead be performed in parallel, or may be performed at different times.

While the term “field” and “record” are used herein, any type of data structure can be employed. For example, relevant data can have preceding headers, or other overhead data proceeding (or following) the relevant data. Alternatively, relevant data can avoid the use of any overhead data, such as headers, and simply be recognized by a certain byte or series of bytes within a serial data stream. Any number of data structures and types can be employed herein.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words in the above detailed description using the singular or plural number may also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The teachings of the invention provided herein can be applied to other systems, not necessarily the system described herein. These and other changes can be made to the invention in light of the detailed description. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above detailed description. While the above description details certain embodiments of the invention and describes the best mode contemplated, no matter how detailed the above appears in text, the invention can be practiced in many ways. Details of the protocol, data model, and processing scheme may vary considerably in its implementation details, while still being encompassed by the invention disclosed herein. As noted above, particular terminology used when describing certain features, or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. A data collection and processing system for use With meter devices that measure a utility, the system comprising:
multiple data collection devices associated with an automatic meter reading system, wherein each of the multiple data collection devices is coupled to multiple meter-reading modules configured for transmitting collected meter-reading information to the data collection devices, and wherein each of the data collection devices generates a message having a payload, the message comprising:
header information identifying a source of the message; and
a first packet having a first type of meter data and a second packet having a second type of meter data distinct from the first type of meter data, wherein the first packet and the second packet comprise at least a portion of the payload; and
a head-end subsystem comprising:
an interlace component for receiving the message from the multiple data collection devices, wherein the message is received over a communication link;
a first specialized packet processor configured for processing only the first type of data;
a second specialized packet processor configured for processing only the second type of data; and
a message organizer component effectively coupled to the first packet processor and the second packet processor, wherein the message organizer is configured for delegating the first packet to the first specialized packet processor and delegating the second packet to the second specialized packet processor.

2. The system of claim 1 further comprising a wireless network configured for communication between the multiple meter-reading modules and the multiple data collection devices.

3. The system of claim 1 wherein the first packet and the second packet include header information having a signature identifying the type of data, and wherein the head-end subsystem further comprises a data store containing signature keys that are checked against the packet signatures.

4. In a utility meter-reading system, a data processing system for processing date collected by an embedded data collection device, the system comprising;
an interface component for receiving a message from the embedded data collection device, wherein the message is received over a communication link, wherein the message contains a first packet having a first type of data and a second packet having data a second type of data distinct from the first type, and wherein the first type of data is utility consumption data collected from one or more utility meters monitored using automatic meter reading techniques;
a first packet processor for processing only the first type of data; and
a second packet processor for processing only the second type of data;

5. The system of claim 4 wherein the first packet processor and the second packet processor process data asynchronously.

6. The system of claim 4 further comprising:
a message organizer component configured for validating a structure of the received message and for delegating the first packet to the first packet processor and the second packet to the second packet processor based on a signature key of the first packet and a signature key of the second packet; and
a data store for use by the message organizer component in delegating the first packet to the first packet processor and delegating the second packet to the second packet processor, wherein the data store has a first key corresponding to data of the first type and a second key corresponding to data of the second type.

7. The system of claim 4 wherein the interface component includes an Active Server Page (ASP) running on an Internet Information Service (IIS) component, and wherein the Active Server Page (ASP) communicates with the message organizer.

8. The system of claim 4 wherein the message organizer component is further configured for data decompression.

9. The system of claim 4 wherein the message organizer component, the first packet processor, and the second packet processor are queued components.

10. The system of claim 4 further comprising an archive component configured for archiving data in the received messages.

11. The system of claim 4 wherein the first packet processor and the second packet processor share the same interface.

12. The system of claim 4 wherein the first type of data is alarm data collected from one or more utility meters.

13. The system of claim 4 wherein the first type of data is tamper data collected from one or more utility meters.

14. The system of claim 4 wherein the first type of data is interval data collected from one or more utility Meters employing solid state demand techniques.

15. The system of claim 4 wherein the first type of data is interval data collected from one or more water utility meters monitoring water consumption.

16. The system of claim 4 wherein the message is a recursive data structure having an additional message within the message.

17. The system of claim 4 wherein the message is encrypted.

18. The system of claim 4 wherein the packet header includes signature information that identifies the type of data in each packet.

19. The system of claim 4 further comprising a message organizer component configured for validating a structure of the received message and for delegating the first packet to the first packet processor and the second packet to the second packet processor based on a signature key of the first packet and a signature key of the second packet.

20. The system of claim 4 wherein the received message is encapsulated in a standard protocol wrapper.

21. A computer-readable medium containing a data structure configured for transmission to a data processor component in an automatic meter reading system, wherein the message includes payload information collected from a data collection device configured for recording consumption data associated with at least one metered device that is monitored by the automatic meter reading system, the message comprising:
header information, wherein the header information includes a device identifier for identifying the device configured for recording consumption data associated with the at least one metered device that is monitored using the automatic meter reading system and a message identifier for identifying the message; and
a first packet containing data of a first type and a second packet containing data of a second type distinct from the first type, wherein the first packet and the second packet comprise at least a portion of a message body for the message, wherein the message body for the message includes data associated with the monitoring of the automatic meter reading system, and wherein the first packet and the second packet each include a header having an identifier identifying the first or second type of data contained in the packet.

22. The computer-readable medium of claim 21 wherein the first packet and the second packet include data in binary form.

23. The computer-readable medium of claim 21 wherein the header information includes data in binary form.

24. The computer-readable medium of claim 21 wherein the message is encapsulated in an HTTP or HTTPS wrapper.

25. The computer-readable medium of claim 21 wherein the computer-readable medium is a logical node in a computer network receiving the contents.

26. The computer-readable medium of claim 21 wherein the computer-readable medium is a computer-readable disk.

27. The computer-readable medium of claim 21 wherein the computer-readable medium is a data transmission medium transmitting a generated data signal containing the contents.

28. The computer-readable medium of claim 21 wherein the computer-readable medium is a memory of a computer system.

29. At an embedded data collection device, a method of generating a message containing collected data destined for processing at a collective processing component in an automatic meter reading system, the method comprising:
generating a first frame corresponding to a first type of data collected by the embedded data collection device and a second frame corresponding to a second type of data collected by the embedded data collection device, wherein the first frame and the second frame include a header containing a signature identifying the type of collected data;
assembling the generated frames into a message, wherein the message includes message header information identifying the data collection device;
encapsulating the message in a standard protocol wrapper, and
transmitting the encapsulated message to the head-end component in the automatic meter reading system via a communication link.

30. The method of claim 29 wherein the embedded data collection device is coupled to one or more meter-reading modules, wherein the frames include one or more data records, and wherein each of the data records has a one-to-one correspondence with the one or more meter-reading modules coupled to the data collection device.

31. A method for processing messages received from multiple data collection devices used in an automatic meter reading system, the method comprising;
receiving a message from a data collection device configured for collecting utility consumption data for use in the automatic meter reading system, the message comprising:
a first packet having a first type of data and a first packet header containing a first identifier, wherein the first type of data includes data recorded at a utility meter; and
a second packet having a second type of data and a second packet header containing a second identifier, wherein the second type of data is distinct from the first type of data;
validating the message, wherein the validating includes looking-up the first and second identifiers in a data base table, and
delegating the first packet to a first processor configured for processing the first type of data and delegating the second packet to a second processor configured for processing the second type of data, wherein the delegating is based, at least in part, on the signature of the packet.

32. The method of claim 31 further comprising modifying the system to handle messages containing a third type of data by adding a third packet processor for processing the third type of data.

33. The method of claim 31, wherein the multiple data collection devices include a first data collection device running on a first software version and a second data collection device running on a second software version, and wherein the first software version includes a first set of data types including the first type of data and the second type of data, and wherein the second software version includes a second set of data types including a third type of data and a fourth type of data.

34. The method of claim 31 wherein the received message is compressed upon receipt and wherein the validating includes decompressing the received message.

35. A system for processing messages received from multiple data collection devices in an automatic meter reading system, the system comprising:
means for receiving a message from a data collection device in the automatic meter reading system, the message comprising:
a first packet having a first type of data and a first packet header containing a first signature; and
a second packet having a second type of data and a second packet header containing a second signature, wherein the second type of data is distinct from the first type of data;
means for validating the message, wherein the validating includes looking up the first and second signatures in a data base table; and
means for delegating the first packet to a first processor configured for processing the first type of data and delegating the second packet to a second processor configured for processing the second type of data, wherein the delegating is based, at least in part, on the signature of the packet.
